(19) United States
(12) Patent Application Publication
(10) Pub. No.: US 2023/0328147 A1
(43) Pub. Date: Oct. 12, 2023

(54) SMART NOTIFICATION SYSTEM

(71) Applicant: Citrix Systems, Inc., Fort Lauderdale, FL (US)

(72) Inventors: Yu Xin, Nanjing (CN); Shihao Qian, Nanjing (CN)

(21) Appl. No.: 17/828,229

(22) Filed: May 31, 2022

Related U.S. Application Data
(63) Continuation of application No. PCT/CN22/85923, filed on Apr. 8, 2022.

(51) Int. Cl. H04L 67/50; H04L 67/55

(52) U.S. Cl. CPC H04L 67/535; H04L 67/55

(57) ABSTRACT

Methods and systems for sending notifications are described herein. A server may determine, a plurality of user devices that are connected with a user account. The server may a plurality of status reports. Each of the plurality of status reports may indicate a currently active level of a respective user device of the plurality of user devices. The server may select, based on analyzing the status reports, one or more user devices that are currently active. The server may cause, on the one or more user devices, display of a notification associated with the user account. In this way, the number of repeated notifications may be reduced.

### FIELD

Aspects described herein generally relate to data communication, and hardware and software related thereto. More specifically, one or more aspects described herein provide systems and methods for selectively sending notifications to user devices based on detecting duplicate notifications intended for different devices.

### BACKGROUND

Nowadays, most users have multiple personal devices. For example, a user may have a laptop, a mobile phone, and a tablet. Each of these personal devices may have the same application installed and linked to the same user account. For example, the laptop, the mobile phone, and the tablet may each have an email application. The email application on each of the devices may be linked to the same email account. If a notification from the email application is sent to the user via each of the laptop, the mobile phone, and the tablet, the user receives repeated notifications multiple times, leading to unnecessary and confusing duplicity between devices.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

If a user has multiple personal devices (e.g., a laptop, a mobile phone, and a tablet) that are associated with the same user account, repeated notifications from the plurality of the personal devices may be received. For example, each of the laptop, the mobile phone, and the tablet may have an email application installed. The email application on each of the personal devices may be linked to the same email account. The user may receive repeated notifications from different personal devices. One on hand, repeated notifications may be useless and disruptive to the user. On the other hand, reviewing a large number of repeated notifications may cause the user to overlook some important notifications. For example, if the user's mobile phone displays ten email notifications, nine of which have already been displayed on other devices and therefore reviewed by the user, the user may delete all the ten notifications without knowing that one of the notifications has not been reviewed yet.

To overcome limitations in the prior art described above, and to overcome other limitations that will be apparent upon reading and understanding the present specification, aspects described herein are directed towards a method of sending notifications based on the active level of each of the user devices that are associated with the same user account. If a notification associated with a user account is received, the notification may be displayed on one or more user devices that are currently active (e.g., the user devices that the user is currently using or otherwise paying attention to). The notification may be prevented from being displayed on the other user devices that are not currently active. In this way, the notification does not have to be displayed on all user devices that are associated with the same user account. The number of repeated notifications may be reduced. The user may be therefore provided a better user experience with less disruption. In addition, with fewer notifications being displayed, the user may be able to pay closer attention to each of the displayed notifications and therefore actually reduce the chance to overlook important notifications.

In at least one implementation, a computing device may determine a plurality of user devices that are connected with a user account. The computing device may receive, from the plurality of user devices, a plurality of status reports. Each of the plurality of status reports may indicate a currently active level of a respective user device of the plurality of user devices. The computing device may analyze the plurality of status reports, select, based on the analyzing and from the plurality of user devices, one or more user devices that are currently active, and cause, on the one or more user devices, display of a notification associated with the user account. A quantity of the one or more user devices is fewer than a quantify of the plurality of user devices.

In some instances, causing display of the notification may further comprise determining that the notification is associated with an application that is not executed on the one or more user devices, modifying the notification to a format suitable to be executed on the one or more user devices and causing, on the one or more user devices, display of the modified notification.

In some instances, each of the plurality of status reports may comprise at least one of: a power status parameter, a screen-lock status parameter, an input event parameter, an audio event status, or a video event status.

In some instances, the computing device may further select, based on the analyzing and among the plurality of user devices, one or more second user devices that are inactive, and may block, the notification from being displayed on the one or more second user devices.

In some instances, the analyzing the plurality of status reports may comprise ranking, based on the current activity level of each of the plurality of user devices, the plurality of user devices.

In some instances, the causing display of a notification may comprise receiving, from an agent of a user device of the plurality of user devices, the notification, and sending, to the agent and based on determining that the user device is active, an instruction to display the notification.

In some instances, the computing device may further receive, from the plurality of user devices and at a time different from a time when the plurality of status reports is received, a plurality of second status reports. Each of the plurality of second status reports may indicate a currently active level of a respective user device, of the plurality of user devices. The computing device may determine, based on the plurality of second status reports, that each of the plurality of user devices is inactive, and store, to a queue, the notification, wherein the queue is configured to store notifications to be displayed in a future time.

In some instances, the causing display of the notification may comprise causing, on a first user device of the one or more user devices, display of the notification, determining the notification is not read by a user associated with the first user device within a predetermined time period, and causing, on a second user device of the one or more user devices, display of the notification.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5A is a block diagram of an example system in which resource management services may manage and streamline access by clients to resource feeds (via one or more gateway services) and/or software-as-a-service (SaaS) applications.

FIG. 5B is a block diagram showing an example implementation of the system shown in FIG. 5A in which various resource management services as well as a gateway service are located within a cloud computing environment.

FIG. 5C is a block diagram similar to that shown in FIG. 5B but in which the available resources are represented by a single box labeled “systems of record,” and further in which several different services are included among the resource management services.

FIG. 5D shows how a display screen may appear when an intelligent activity feed feature of a multi-resource management system, such as that shown in FIG. 5C, is employed.

FIG. 6 depicts an illustrative computing environment in accordance with one or more illustrative aspects described herein.

FIG. 7A depicts a flow diagram of an example method for determining the active level of user devices in accordance with one or more illustrative aspects described herein.

FIG. 7B depicts illustrative status reports in accordance with one or more illustrative aspects described herein.

FIG. 8 depicts a flow diagram of an example method for sending notifications in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

Repeated notifications may be received by a user from the plurality of the user's personal devices if all those devices are linked to the same user account. For example, the same email notification may be displayed on the user's laptop, mobile phone, and tablet. One on hand, repeated notifications may be useless and disruptive to the user. On the other hand, reviewing a large number of repeated notifications may cause the user to overlook some important notifications. For example, if the user's mobile phone displays ten email notifications, nine of which have already been displayed on the laptop and therefore reviewed by the user, the user may delete all the ten notifications without knowing that one of the notifications has not been reviewed yet. To overcome limitations, aspects described herein are directed towards a method of sending notifications based on the active level of each of the user devices that are associated with the same user account. If a notification associated with a user account is received, the notification may be displayed on one or more user devices that are currently active. The notification may be prevented from being displayed on the other user devices that are not currently active. In this way, the notification does not have to be displayed on all user devices. The number of repeated notifications may be reduced. The user may be therefore provided a better user experience with fewer disruptions. In addition, with fewer notifications being displayed, the user may be able to pay closer attention to all notifications and therefore actually reduce the chance to overlook important notifications.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computing Architecture

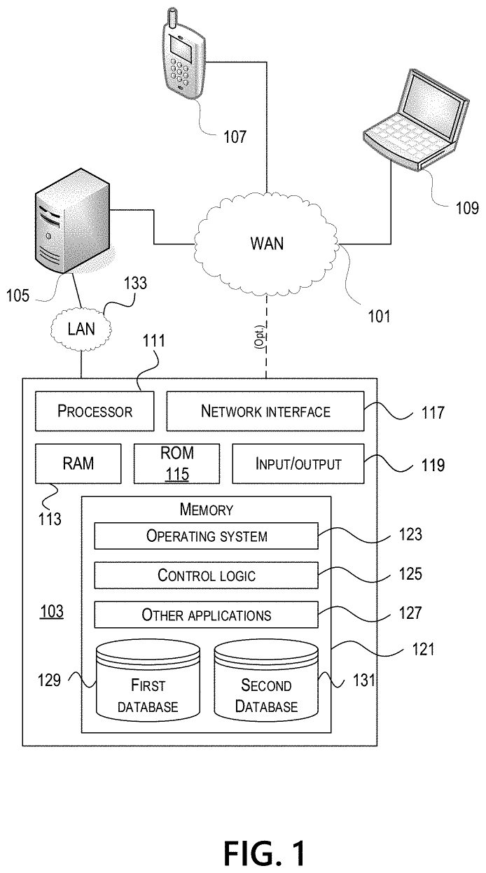

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

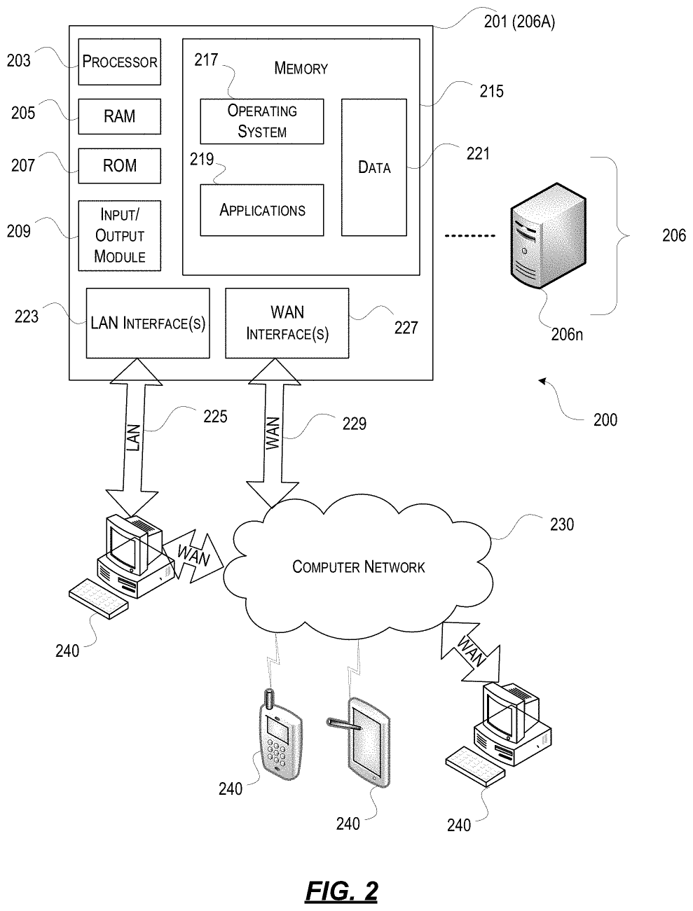

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

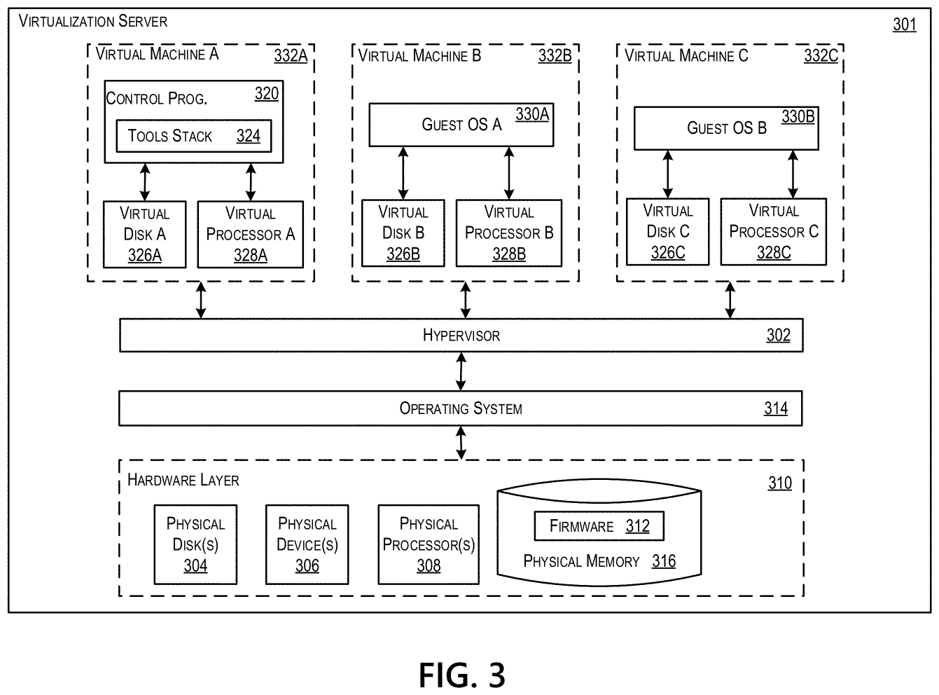

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e g, many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

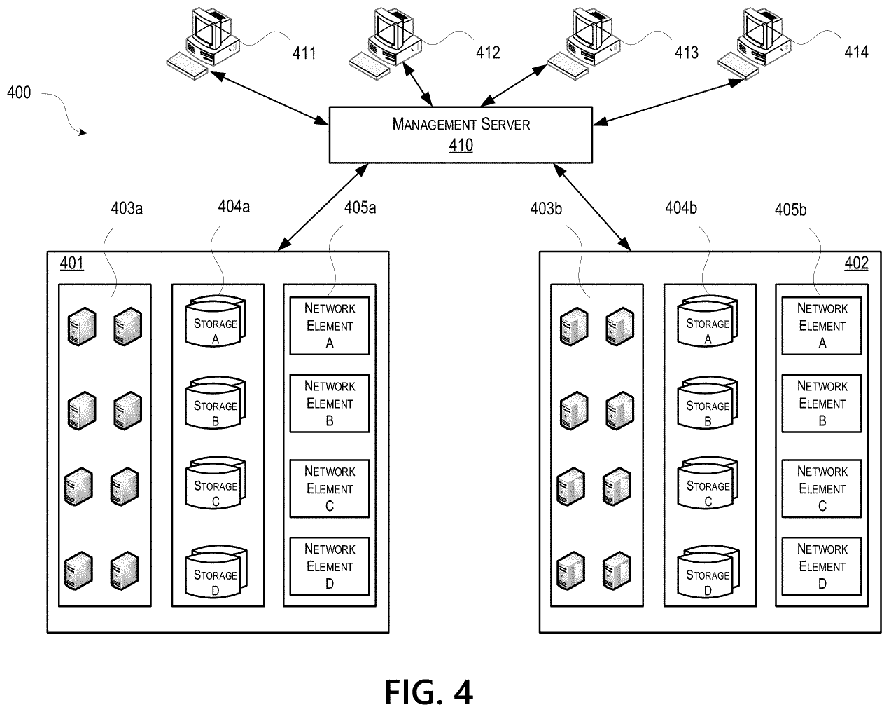

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

Resource Management System

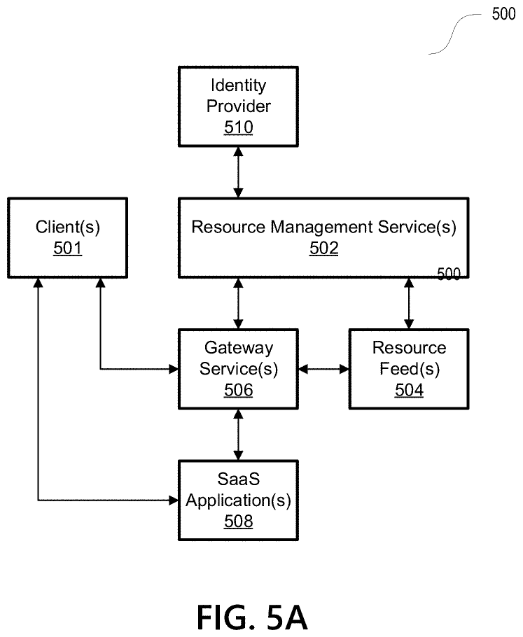

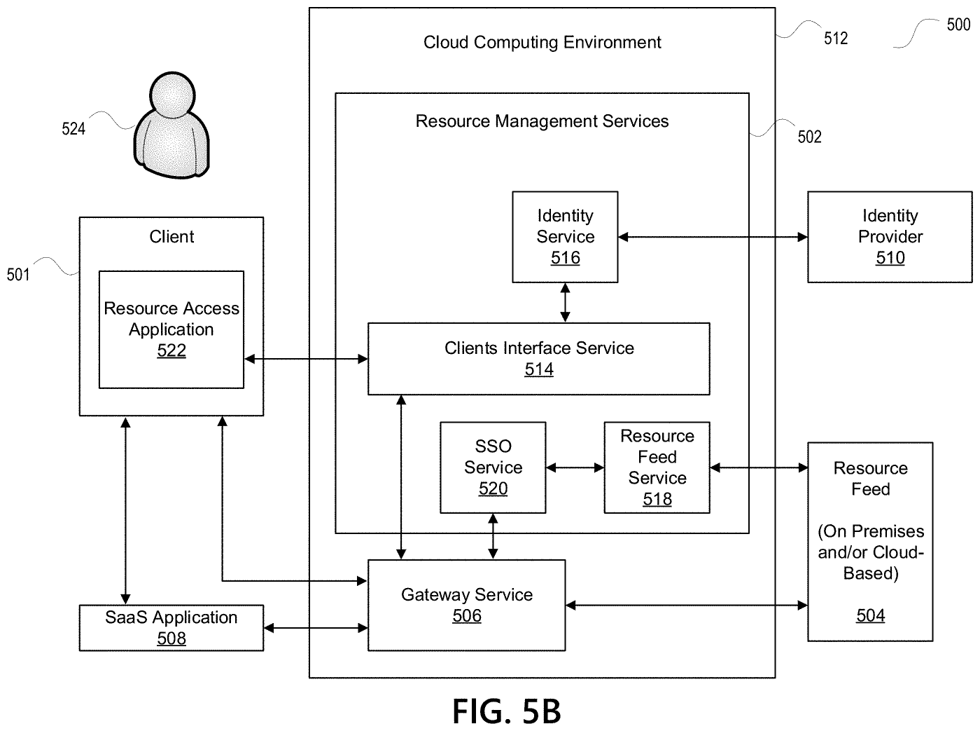

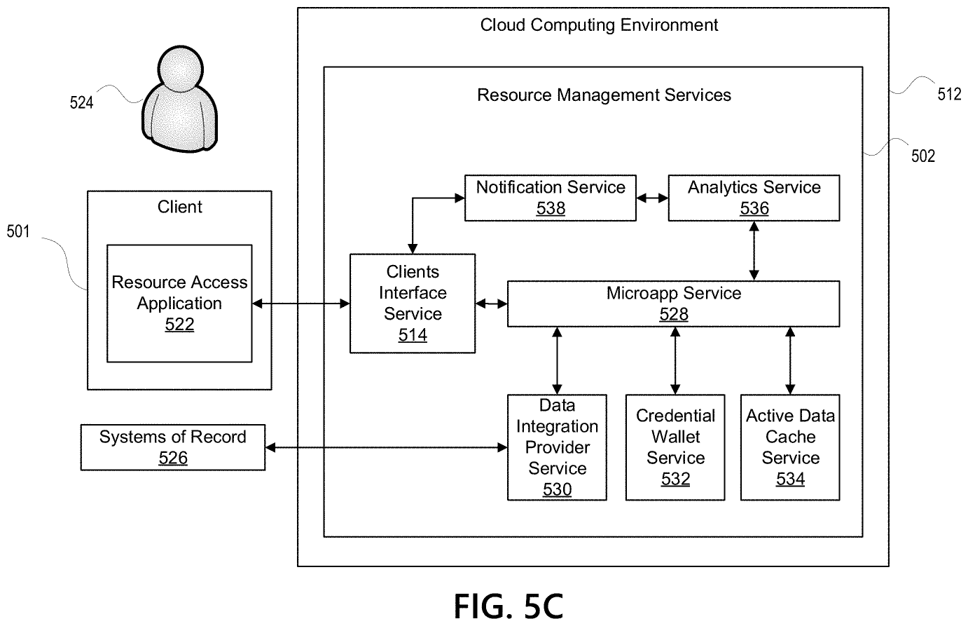

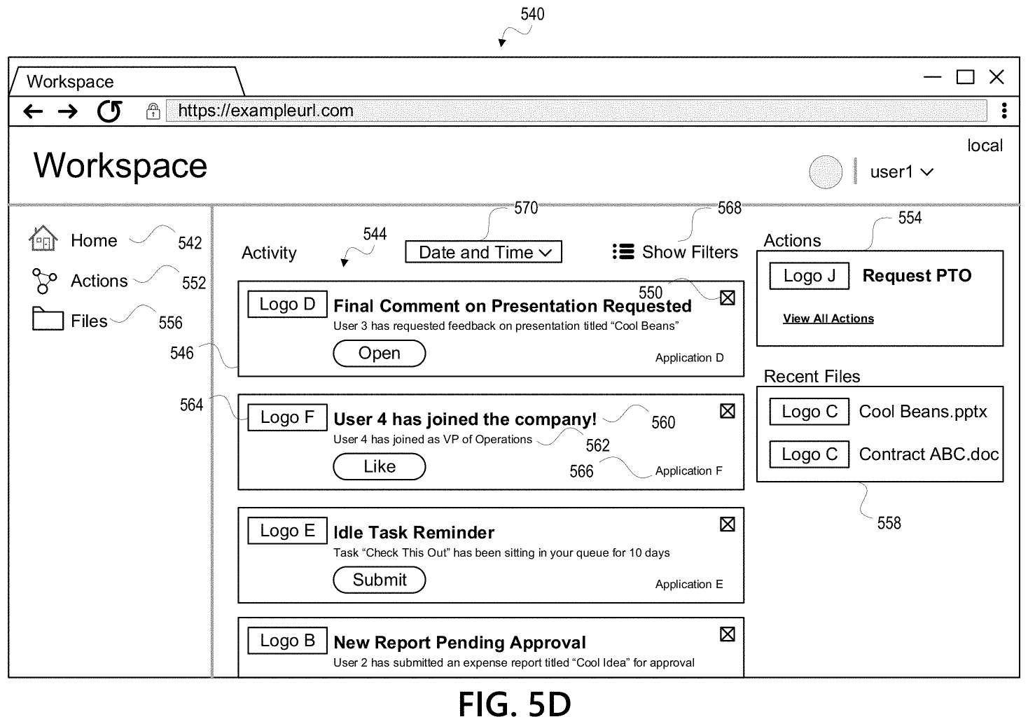

FIG. 5A is a block diagram of an example multi-resource access system 500 in which one or more resource management services 502 may manage and streamline access by one or more clients 501 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 501 and, following authentication, identify one of more resources the user is authorized to access. In response to the user selecting one of the identified resources, the resource management service(s) 502 may send appropriate access credentials to the requesting client 501, and the client 501 may then use those credentials to access the selected resource. For the resource feed(s) 504, the client 501 may use the supplied credentials to access the selected resource via a gateway service 506. For the SaaS application(s) 508, the client 501 may use the credentials to access the selected application directly.

The client(s) 501 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 501, one or more file repositories and/or file sharing systems, one or more secure browser services, one or more access control services for the SaaS applications 508, one or more management services for local applications on the client(s) 501, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 501) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 501 may use a resource access application 522 to communicate with the client interface service 514 as well as to present a user interface on the client 501 that a user 524 can operate to access the resource feed(s) 504 and/or the SaaS application(s) 508. The resource access application 522 may either be installed on the client 501, or may be executed by the client interface service 514 (or elsewhere in the multi-resource access system 500) and accessed using a web browser (not shown in FIG. 5B) on the client 501.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 501 to be redirected to the cloud-based identity service to complete an authentication process. The cloud-based identity service may then cause the client 501 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 501. The list of available resources may, for example, be presented on the user interface of the client 501 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 501, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 501 may proceed to access the selected resource.

When the user 524 selects a local application, the resource access application 522 may cause the selected local application to launch on the client 501. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 501 may then launch the identified browser and initiate a connection to the gateway service 506. The gateway service 506 may then request an assertion from the single sign-on service 520. Upon receiving the assertion, the gateway service 506 may cause the identified browser on the client 501 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 501 to access the selected SaaS application 508.

In some embodiments, the preferred browser identified by the gateway service 506 may be a specialized browser embedded in the resource access application 522 (when the resource access application 522 is installed on the client 501) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 501 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 501, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “decline,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 501 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 501. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically cause active data to be pulled from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 501 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 501 as a push notification to the user 524.

In some embodiments, a process for processing a user-initiated action via a microapp may operate as follows. The client 501 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce®, Ariba®, Concur®, RightSignature®, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system or record to which the notification 546 corresponds, thus helping the user understand the proper context with which to decide how best to respond to the notification 546. In some implementations, one of more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D) and/or an “application” mode (not illustrated) may be selected (e.g., using die element. 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user-interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user-interface element 552 or by selecting a desired action from a list 554 of recently and/or commonly used microapp actions. As shown, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files.

Although not shown in FIG. 5D, it should be appreciated that, in some implementations, additional resources may also be accessed through the screen 540 by clicking on or otherwise selecting one or more other user interface elements that may be presented on the screen. For example, in some embodiments, one or more virtualized applications may be accessible (e.g., via a Citrix Virtual Apps and Desktops™ service) by clicking on or otherwise selecting an “apps” user-interface element (not shown) to reveal a list of accessible applications and/or one or more virtualized desktops may be accessed (e.g., via a Citrix Virtual Apps and Desktops® service) by clicking on or otherwise selecting a “desktops” user-interface element (not shown) to reveal a list of accessible desktops.

The activity feed shown in FIG. 5D provides significant benefits, as it allows a user to respond to application-specific events generated by disparate systems of record without needing to navigate to, launch, and interface with multiple different native applications.

Notification Sending System

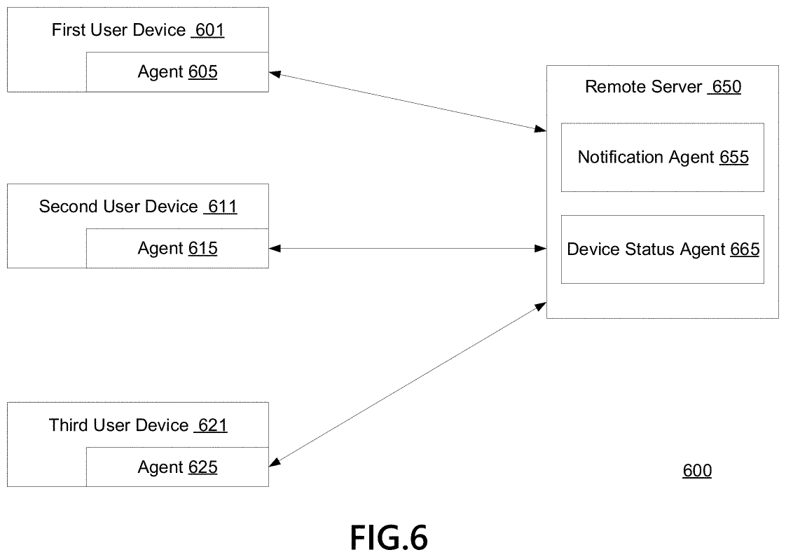

FIG. 6 depicts an illustrative computing environment for sending notifications in accordance with one or more aspects described herein. The system 600 may comprise a plurality of computing devices, including a plurality of user devices (e.g., first user device 601, second user device 611, and third user device 621) and a remote server 650.

The plurality of user devices may be associated with a user account of a user. For example, the first user device 601 may be a laptop of a user. The second user device 611 may be a mobile phone of the user. The third user device 621 may be a tablet of the user. For example, each of the plurality of user devices may be a client device 501 as depicted in FIGS. 5A-5D. The user account may be an account of an application, an account of an operation system, or any other type of account. For example, the account may be an account of a Citrix Workspace application. Each of the user devices 601, 611, and 621 may be logged in to the same user account.

A remote server 650 may be configured to communicate with the plurality of client devices. The remote server 650 may include one or more computing devices and/or other computer components (e.g., processors, memories, communication interfaces, servers, server blades, or the like). For example, the remote server 650 may be and/or include any of data server 103 or web server 105 (as depicted in FIG. 1), server 206 (as depicted in FIG. 2), virtualization server 301 (as depicted in FIG. 3), management server 410 (as depicted in FIG. 4), resources management service(s) 502, cloud computing environment 512 (as depicted in FIGS. 5A-5C), or any other computing devices. The communication may be via one or more agents (notification agent 655 and device status agent 665) on the remote server 650 and one or more agents on each of the plurality of user devices (e.g., agent 605 on the first user device 601, agent 615 on the second user device 611, and agent 625 on the third user device 621).

Each of the plurality of user devices may have a plurality of applications installed. An application may be executed either locally on the user device, or remotely on another device (e.g., the remote server 650) and accessed by the user device via a remote protocol. Some of the applications on each of the user devices may be overlapped. For example, each of the user devices 601, 611, and 621 may have an email application installed. In another example, both the first user device 601 and the second user device 611 may have a social network application installed. The user may not want to receive repeated notifications from different devices because repeated notifications may be annoying and useless to the user. In addition, reviewing a large number of repeated notifications may cause the user to overlook some important notifications. For example, if the user's mobile phone displays ten email notifications, nine of which have already been displayed on the laptop and therefore reviewed by the user, the user may delete all the ten notifications without knowing that one of the notifications has not been reviewed yet.

To efficiently display notifications, the remote server 650 may be configured to monitor notifications sent to each of the plurality of user devices (e.g., via the notification agent 655). The remote server 650 may determine one or more user devices are currently active and one or more other user devices are currently inactive. As may be described in further detail below, determining active and inactive devices may be implemented by analyzing the status of each of the plurality of user devices periodically. The remote server 650 may allow the notification to be displayed on the currently active user devices and prevent the notification to be displayed on the currently inactive user devices. For example, if the remote server 650 determines that the user is currently writing documents on the first user device 601, the remote server 650 may cause a display of the notification on the first user device 601. no matter whether the notification was originally sent to the first user device 601 or not. By contrast, if the remote server 650 determines that a second user device 611 is currently inactive (e.g., the screen is locked or the device is in a sleep mode), the remote server 650 may block the notification from being displayed on the second user device 611, even if the notification was originally sent to the second user device 611. In this way, a notification may be displayed to the user device that the user is currently paying attention to, and therefore increase the chance that the notification to be read by the user. Meanwhile, the number of repeated notifications may be reduced.

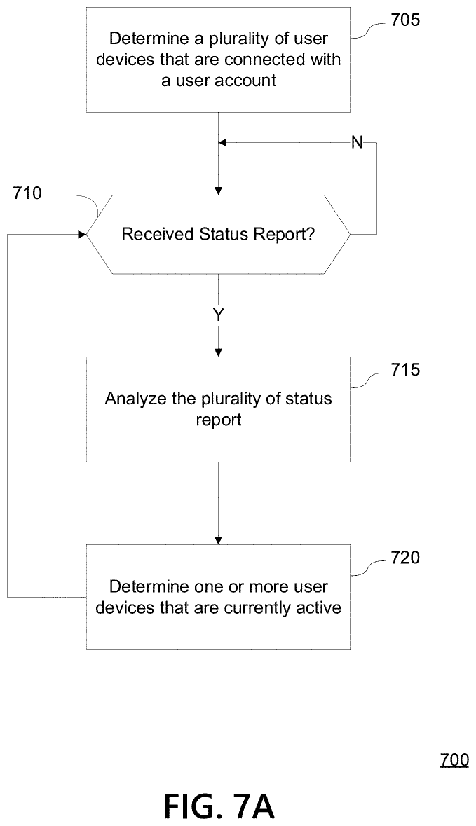

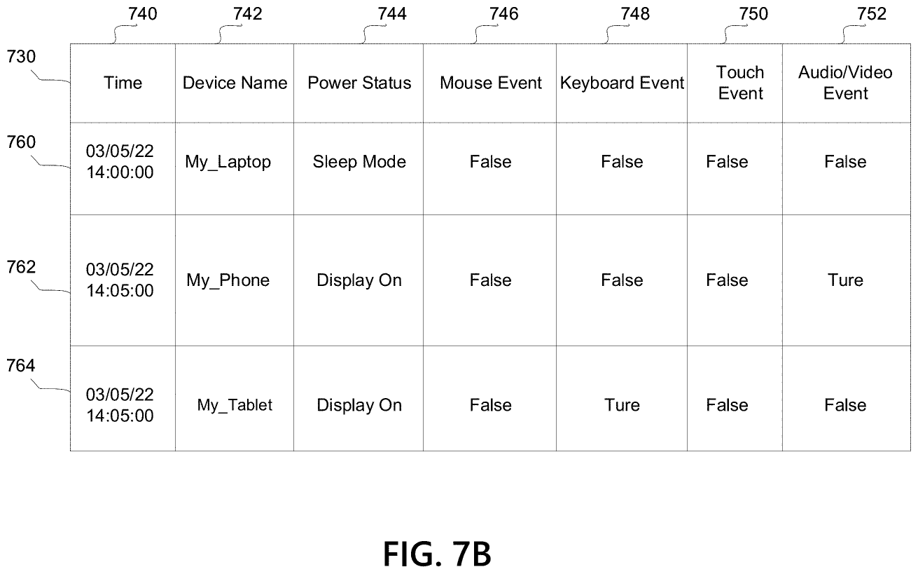

FIG. 7A depicts a flow chart for determining user devices that is currently active. The steps of method 700 may be performed by a system comprising the remote server 650 as depicted in FIG. 6. Alternatively or additionally, some or all of the steps of method 700 may be performed by one or more other computing devices. The steps of method 700 may be modified, omitted, and/or performed in other orders, and/or other steps added.

At step 705, the system may determine a plurality of user devices (e.g., the first user device 601, second user device 611, and third user device 621 shown in FIG. 6) that are connected with the same user account. The user account may be an account of an application, an account of an operation system, or any other type of account. The system may be configured to manage the user account and may determine that the plurality of user devices are currently logged into the user account. For example, the account may be an account of a Citrix Workspace application. The system may manage the workspace associated with the user. The system may store a user profile that records the device identifier of each of the plurality of user devices that are currently logged in to the account.

At step 710, the system may determine whether one or more status reports are received. Each of one or more status reports may indicate a currently active level of a respective user device of the plurality of user devices. For example, after a user device logs in into the user account, the user device may produce an initial status report that indicates the currently active level and may send the report to the system. For example, the status report may be produced or sent via an agent on the user device (e.g., agent 605 on the first user device 601, agent 615 on the second user device 611, and agent 625 on the third user device 621 as shown in FIG. 6). A status report may comprise at least one of a power status parameter, a screen-lock status parameter, an input event parameter, an audio event status, or a video event status. The status report may be updated. The updated status report may be generated periodically (e.g., every 10 seconds), or may be generated when a certain event is detected (e.g., the user makes certain input via the device, the device switches from a sleep mode to an active mode, etc.). Updated status reports may also be sent to the system, so that the system may determine the most up-to-date active level of the user device. If the system receives new status reports from any one or more user devices, the method may proceed to step 715. If the system does not receive new status reports, the system may wait until new status reports are received.

FIG. 7B depicts illustrative status reports. As shown in FIG. 7B, Table 730 depicts information of status reports recently received from three user devices that are associated with the same user account. Each column of Table 730 may show information in one data field of the status report. Each data field may indicate an aspect of information associated with the status report. For example, data field 740 may indicate the time when the status report is generated or updated. Data field 742 may indicate the device name. Data field 744 may indicate the power status of the user device. Data field 746 may indicate whether a mouse event is detected during a certain period of time (e.g., whether any input from the mouse connected to the user device has been detected). The certain time period may be a preset time period (e.g., within 10 seconds before the status report was generated), the time period from the last status report was generated to the current status report was generated, or any other time period that may be indicative to whether the user is currently paying attention to the user device. Data field 748 may indicate whether a keyboard event is detected during a certain period of time (e.g., whether any input from the keyboard connected to the user device is detected). Data field 750 may indicate whether a touch event is detected during a certain period of time (e.g., whether any input from a touchpad or a touch panel is detected). Data field 752 may indicate whether an audio/video (AV) event is detected during a certain period of time (e.g., whether any audio or video signal is currently output from the user device or input to the user device). The data fields shown in FIG. 7B are merely examples, and other data fields are possible.

As shown in Table 730, each row may show the information of the status report of a particular user device. For example, a status report 760 may be associated with a device named “My_Laptop.” The status report 760 may be generated on Mar. 5, 2022, at 14:00:00. The power status may indicate the device is in sleep mode. The value of the mouse event, keyboard event, touch event, and audio/video event may be all “False,” since the user is not using the My_Laptop device. A status report 762 may be associated with a device named “My_Phone.” The status report 762 may be generated on Mar. 5, 2022, at 14:05:00. The power status may indicate the display of the device is on. The value of the mouse event and keyboard event may be False since My_Phone may be a mobile device that does not have a mouse or a keyboard. The value of the touch event may be “False.” The audio/video event may be “True,” which may indicate the user is viewing a video or listening to a song via the My_Phone device. A status report 764 may be associated with a device named “My_Tablet.” The status report 764 may be generated on Mar. 5, 2022, at 14:05:00. The power status may indicate the display of the device is on. The value of the mouse event may be “False.” The value of the keyboard event may be “Ture,” which may indicate the user is typing via the My_Tablet device. The touch event and audio/video event may be “False.”

It is appreciated that the number of the devices, as well as the value in the status report for each device, are merely examples. Other numbers of user devices that are associated with the user account may be possible. Other values in the status report may be possible. For example, each of the user devices may update the status report at the same time, or each of the user devices may have its own schedule to update the status report. As shown in Table 730, the most recent status report from the My_Laptop device may be received earlier than the other two user devices, which may indicate My_Laptop device generates updated status report less frequent than the other two user devices (e.g., because My_Laptop device is currently on a sleep mode).

Referring back to FIG. 7A, at step 715, the system may analyze one or more status reports that are newly received. For example, the system may calculate an active score for each of the user devices that generates a status report, and determine which user devices are currently active.

Consistent with the status reports depicted in FIG. 7B, the system may analyze the status reports 760, 762, and 764 based on the value in each data field and/or the weight assigned to each data field. For example, for the power status data field 744, if the value is “sleep mode,” the corresponding score may be 0. If the value is “display on,” the corresponding score may be 1. Other values and/or other corresponding scores may be possible. For example, if the screen of the user device is newly locked but the user device has not yet been into a sleep mode, the corresponding score may be 0.5.

Similarly, for each of the mouse event data field, keyboard event data field, touch event data field, and the audio/video event data field, the value of the “Ture” may correspond to a score of 1, and the value of “False” may correspond to a score of 0. A weight may be assigned to each of the mouse event data field 746, keyboard event data field 748, touch event data field 750, and/or the audio/video event data field 752. Those data fields may be each assigned the same weight or may be different weights. For example, the weight of each of the mouse event 746, keyboard event 748, and touch event data field 750 may be 1, while the weight of audio/video event data field 752 may be 0.8. This may be because, if the user is actively typing on a first user device, the user's attention may be very focused on the first user device and may be more likely to notice a notification that pops out at the first user device. By contrast, if the user is listening to music via a second user device, while the user's attention is still partially on the second user device, the user may be less likely to notice a notification that pops out at the second user device. It is appreciated that the weights are merely examples, and other weights may be assigned. For example, a keyboard event 746 may be assigned an equal or lower weight than an audio/video event. Consistent with the example weight and value discussed above, the status report 760 may indicate the active score of My_Laptop is 0+0+0+0+0=0. The status report 762 may indicate the active score of My_Phone is 1+0+0+0+0.8=1.8. The status report 764 may indicate the active score of My_Tablet is 1+0+1+0+0=2.

The system may rank the plurality of user devices based on the currently active level of each of the plurality of user devices. Consistent with the example scores discussed above, the system may determine My_Tablet device is currently the most active user device, My_Phone device is currently the second active user device, and My_Laptop device is currently the least active user device. It is appreciated weights for each data field or each value in a data field may be assigned differently, and the ranking of the user devices may be different accordingly. For example, if an audio/video event is assigned a higher weight than a keyboard event, then the My_Phone device may be ranked higher than the My_Laptop device.

At step 720, the system may select, based on the analysis and from the plurality of user devices, one or more user devices that are currently active. For example, the system may select the user device with the highest score (e.g., My_Tablet in the above example) as the user device that is currently active. In another example, the system may determine that any user device that has an active score exceeding a threshold is an active device (e.g., if the threshold is 1, both My_Phone and My_Tablet are currently active). The system may also select the one or more user devices based on other standards.

A quantity of the one or more user devices, which are deemed to be active, may be fewer than a quantify of the plurality of user devices that are associated with the user account. For example, if there are three user devices that are associated with the user account, the system may select no more than two user devices as the currently active devices in order to reduce repeated notifications.

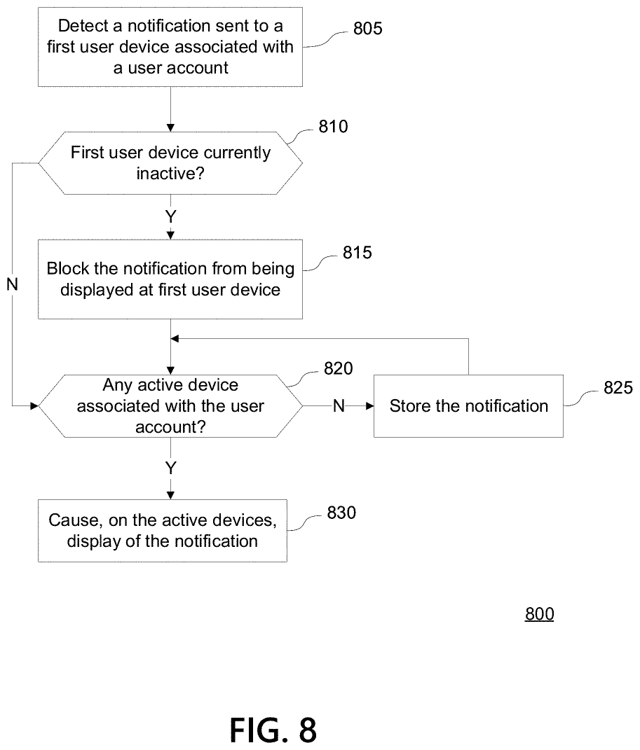

The currently active device may be updated from time to time based on updated status reports that the system receives. The user devices that are determined to be currently active may be configured to display notifications to the user, as may be discussed in connection with FIG. 8 below.

FIG. 8 depicts a flow chart for sending notifications based on user devices that are currently active. The steps of method 800 may be performed by a system comprising the plurality of user devices (e.g., the first user device 601, the second user device 611, and the third user device 621) and the remote server 650 as depicted in FIG. 6. Alternatively or additionally, some or all of the steps of method 800 may be performed by one or more other computing devices. The notifications may be sent based on which of the plurality of user devices are currently active, which may be determined in a way similar to FIGS. 7A to 7B. The steps of method 800 may be modified, omitted, and/or performed in other orders, and/or other steps added.

At step 805, the system may detect a notification is sent to a first user device (e.g., user device 601 shown in FIG. 6). The first user device 601 may be associated with a user account. The system may detect the notification by receiving a message from an agent (e.g., agent 605) of the first user device 601. The message may either comprise the entire notification, or may comprise information regarding the notification (e.g., the application associated with the notification, timestamp when the notification is received, etc.). For example, after the first user device 601 logs in to the user account, the agent 605 may establish a connection with the system (e.g., the notification agent 655 on the remote server 650). The agent 605 may intercept the notification and send the notification or information of the notification to the notification agent 655. The agent 605 may prevent the notification from being displayed on the first user device 601 before receiving instructions from the system.

At step 810, the system may determine whether the first user device 601 is currently inactive. For example, the system may determine whether the first user device 601 is currently active or not based on the most recent status report, as may be discussed in connection with FIGS. 7A to 7B. If the first user device 601 is a user device that is currently inactive (e.g., if the first user device 601 is the My_Laptop device as shown in FIG. 7B), the method may proceed to step 815. If the system determines the first user device 601 is active, the method may proceed to step 820.

At step 815, the system may block the notification from being displayed on the first user device 601. The system may send (e.g., via the notification agent 655) to the first user device 601 an instruction not to display the notification on the first user device 601 based on the first user device 601 is currently inactive. The agent 605 on the first user device 601 may drop the notification or store the notification in a storage location for future use.

At step 820, the system may determine whether there are any active devices associated with the user account. The system may maintain a user profile that lists a plurality of user devices (the first user device 601, the second user device 611, and the third user device 621 as shown in FIG. 6) that are associated with the user account. The user profile may also indicate whether each of the plurality of user devices is currently active or not (e.g., based on the most recent status report of each device as may be discussed in FIGS. 7A to 7B). If the system determines that no user device associated with the user account is currently active, the method may proceed to step 825. If the system determines that one or more user devices are currently active, the method may proceed to step 830.

At step 825, the system may store the notification. For example, the notification may be stored in a queue. The queue may be stored in a database associated with the system. The queue may be configured to store notifications to be displayed in a future time. The method may proceed back to step 820 and wait for any user devices to become active. The system may wait for an updated status report that indicates a user device becomes active. For example, if the user unlocks the second user device 611 and starts making input via the touch panel of the second user device 611, an updated status report may reflect this change and the system may determine the second user device 611 becomes active. After any user devices become active, the method may proceed to step 830.

At step 830, the system may cause, on the one or more active devices, a display of the notification that has been received at step 805. The system may obtain the notification from the first user device 601 and send the notification to each of the one or more active devices. For example, the notification, together with an instruction to display the notification, may be sent to the agent of each of the one or more active user devices.

In some instances, a user device that is currently active may not have installed the application that is associated with the notification. For example, the notification may be a push notification from a social media application. The user may have installed the social media application on the user's mobile phone, but not on the user's tablet. However, the user's tablet may be the only device that is currently active. The system may modify the notification into another format that is readable by the user's tablet. Additionally or alternatively, the system may add additional information associated with the notification. For example, the system may modify the social media notification into a text message and may add information about the social media application into the modified text message. The system may send the modified notification to the currently active user device for display.

The system may also determine whether there are any notifications that were previously stored in the queue discussed at step 825. For example, there may have been several hours during which no user devices associated with the user account are active, and a plurality of notifications may have been stored in the queue without being displayed to the user. If the system determines that one or more notifications were previously stored in the queue, the system may also cause a display of the one or more previously-stored notifications on the one or more active devices. After the previously-stored notifications have been displayed, the system may clear the queue so that the notification does not have to be displayed again in the future.

If more than one user device is currently active, the system may determine which user device(s) should display the notification. In some instances, the system may send the notification to all user devices that are currently active. In some instances, the system may send the notification to less than all user devices that are currently active. For example, the system may determine which active user device should display the notification based on a preferred list. The preferred list may be preset by the user and stored in the system. For example, the user may prefer to receive notifications at the user's laptop over the user's mobile phone. If both the laptop and the mobile phone are currently active, the system may send the notification to the laptop based on the preferred list. In other instances, the system may determine the most active user device among the currently active devices. For example, consistent with the example discussed in connection with FIG. 7B, the system may determine the user device having the highest active score (e.g., the My_Tablet device as shown in FIG. 7B) as the most active user device. The system may cause a display of the notification to the most active user device first. The system may determine whether the notification is read by the user within a predetermined time period. If the notification is not read by the user within the predetermined time period, the system may cause a display of the notification to other active user devices (e.g., a second most active user device). Consistent with FIG. 7B, if the notification is not read by the user within a predetermined time period, the system may cause a display of the notification to the My_Phone device.

In this way, the system may send notifications to a user efficiently and reduce repeated notifications.

The following paragraphs (M1) through (M8) describe examples of methods that may be implemented in accordance with the present disclosure.

(M1) A method comprising: determining, by a computing device, a plurality of user devices that are connected with a user account; receiving, from the plurality of user devices, a plurality of status reports, wherein each of the plurality of status reports indicates a currently active level of a respective user device of the plurality of user devices; analyzing the plurality of status reports; selecting, based on the analyzing and from the plurality of user devices, one or more user devices that are currently active, wherein a quantity of the one or more user devices is fewer than a quantify of the plurality of user devices; and causing, on the one or more user devices, display of a notification associated with the user account.

(M2) A method may be performed as described in paragraph (M1), wherein causing display of the notification further comprises: determining that the notification is associated with an application that is not executed on the one or more user devices; modifying the notification to a format suitable to be executed on the one or more user devices; and causing, on the one or more user devices, display of the modified notification.

(M3) A method may be performed as described in any of paragraphs (M1) through (M2), wherein each of the plurality of status reports comprises at least one of: a power status parameter, a screen-lock status parameter, an input event parameter, an audio event status, or a video event status.

(M4) A method may be performed as described in any of paragraphs (M1) through (M3), further comprising: selecting, based on the analyzing and among the plurality of user devices, one or more second user devices that are inactive; and blocking, the notification from being displayed on the one or more second user devices.

(M5) A method may be performed as described in any of paragraphs (M1) through (M4), wherein the analyzing the plurality of status reports comprises ranking, based on the current activity level of each of the plurality of user devices, the plurality of user devices.

(M6) A method may be performed as described in any of paragraphs (M1) through (M5), wherein the causing display of a notification comprises: receiving, from an agent of a user device of the plurality of user devices, the notification; and sending, to the agent and based on determining that the user device is active, an instruction to display the notification.

(M7) A method may be performed as described in any of paragraphs (M1) through (M6), further comprising: receiving, from the plurality of user devices and at a time different from a time when the plurality of status reports is received, a plurality of second status reports, wherein each of the plurality of second status reports indicates a currently active level of a respective user device, of the plurality of user devices; determining, based on the plurality of second status reports, that each of the plurality of user devices is inactive; and storing, to a queue, the notification, wherein the queue is configured to store notifications to be displayed in a future time.

(M8) A method may be performed as described in any of paragraphs (M1) through (M7), wherein the causing display of the notification comprises: causing, on a first user device of the one or more user devices, display of the notification; determining the notification is not read by a user associated with the first user device within a predetermined time period; and causing, on a second user device of the one or more user devices, display of the notification.

The following paragraphs (A1) through (A6) describe examples of apparatuses that may be implemented in accordance with the present disclosure.

(A1) An apparatus comprising: one or more processors; and memory storing instructions that, when executed by the one or more processors, cause the apparatus to: determine a plurality of user devices that are connected with a user account; receive, from the plurality of user devices, a plurality of status reports, wherein each of the plurality of status reports indicates a currently active level of a respective user device of the plurality of user devices; analyze the plurality of status reports; select, based on the analyzing and from the plurality of user devices, one or more user devices that are currently active, wherein a quantity of the one or more user devices is fewer than a quantify of the plurality of user devices; and cause, on the one or more user devices, display of a notification associated with the user account.

(A2) An apparatus may be performed as described in paragraph (A1), wherein each of the plurality of status reports comprises at least one of: a power status parameter, a screen-lock status parameter, an input event parameter, an audio event status, or a video event status.

(A3) An apparatus may be performed as described in any of paragraphs (A1) through (A2), wherein the instructions, when executed by the one or more processors, cause the apparatus further to: select, based on the analyzing and among the plurality of user devices, one or more second user devices that are inactive; and block, the notification from being displayed on the one or more second user devices.

(A4) An apparatus may be performed as described in any of paragraphs (A1) through (A3), wherein the instructions, when executed by the one or more processors, cause the apparatus to cause display of the notification by performance of actions comprising: receiving, from an agent of a user device of the plurality of user devices, the notification; and sending, to the agent and based on determining that the user device is active, an instruction to display the notification.

(A5) An apparatus may be performed as described in any of paragraphs (A1) through (A4), wherein the instructions, when executed by the one or more processors, cause the apparatus further to: receive, from the plurality of user devices and at a time different from a time when the plurality of status reports is received, a plurality of second status reports, wherein each of the plurality of second status reports indicates a currently active level of a respective user device, of the plurality of user devices; determine, based on the plurality of second status reports, that each of the plurality of user devices is inactive; and store, to a queue, the notification, wherein the queue is configured to store notifications to be displayed in a future time.

(A6) An apparatus may be performed as described in any of paragraphs (A1) through (A5), wherein the instructions, when executed by the one or more processors, cause the apparatus to cause display of the notification by performance of actions comprising: causing, on a first user device of the one or more user devices, display of the notification; determining the notification is not read by a user associated with the first user device within a predetermined time period; and causing, on a second user device of the one or more user devices, display of the notification.

The following paragraphs (CRM1) through (CRM6) describe examples of computer-readable media that may be implemented in accordance with the present disclosure.

(CRM1) A non-transitory computer-readable medium storing instructions that, when executed by one or more processors of a computing device, cause determining a plurality of user devices that are connected with a user account; receiving, from the plurality of user devices, a plurality of status reports, wherein each of the plurality of status reports indicates a currently active level of a respective user device of the plurality of user devices; analyzing the plurality of status reports; selecting, based on the analyzing and from the plurality of user devices, one or more user devices that are currently active, wherein a quantity of the one or more user devices is fewer than a quantify of the plurality of user devices; and causing, on the one or more user devices, display of a notification associated with the user account.

(CRM2) A non-transitory computer-readable medium may be performed as described in paragraph (CRM1), wherein each of the plurality of status reports comprises at least one of: a power status parameter, a screen-lock status parameter, an input event parameter, an audio event status, or a video event status.

(CRM3) A non-transitory computer-readable medium may be performed as described in any of paragraphs (CRM1) through (CRM2), wherein the instructions, when executed by the one or more processors, cause the computing device further to perform actions comprising: selecting, based on the analyzing and among the plurality of user devices, one or more second user devices that are inactive; and blocking, the notification from being displayed on the one or more second user devices.

(CRM4) A non-transitory computer-readable medium may be performed as described in any of paragraphs (CRM1) through (CRM3), wherein the instructions, when executed by the one or more processors, cause the computing device to analyze the plurality of status reports by ranking, based on the current activity level of each of the plurality of user devices, the plurality of user devices.

(CRM5) A non-transitory computer-readable medium may be performed as described in any of paragraphs (CRM1) through (CRM4), wherein the instructions, when executed by the one or more processors, cause the computing device to cause display of the notification by performance of actions comprising: receiving, from an agent of a user device of the plurality of user devices, the notification; and sending, to the agent and based on determining that the user device is active, an instruction to display the notification.

(CRM6) A non-transitory computer-readable medium may be performed as described in any of paragraphs (CRM1) through (CRM5), wherein the instructions, when executed by the one or more processors, cause the computing device further to perform actions comprising: receiving, from the plurality of user devices and at a time different from a time when the plurality of status reports is received, a plurality of second status reports, wherein each of the plurality of second status reports indicates a currently active level of a respective user device, of the plurality of user devices; determining, based on the plurality of second status reports, that each of the plurality of user devices is inactive; and storing, to a queue, the notification, wherein the queue is configured to store notifications to be displayed in a future time.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

1. A method comprising:
determining, by a computing device, a plurality of user devices that are connected with a user account;
receiving, from the plurality of user devices, a plurality of status reports, wherein each of the plurality of status reports indicates a currently active level of a respective user device of the plurality of user devices;
analyzing the plurality of status reports;
selecting, based on the analyzing and from the plurality of user devices, one or more user devices that are currently active, wherein a quantity of the one or more user devices is fewer than a quantity of the plurality of user devices; and
causing, on the one or more user devices, display of a notification associated with the user account, wherein causing display of the notification further comprises:
determining that the notification is associated with an application that is not executed on the one or more user devices;
modifying the notification to a format suitable to be executed on the one or more user devices; and
causing, on the one or more user devices, display of the modified notification.

2. (canceled)

3. The method of claim 1, wherein each of the plurality of status reports comprises at least one of:
a power status parameter, a screen-lock status parameter, an input event parameter, an audio event status, or a video event status.

4. The method of claim 1, further comprising:
selecting, based on the analyzing and among the plurality of user devices, one or more second user devices that are inactive; and
blocking, the notification from being displayed on the one or more second user devices.

5. The method of claim 1, wherein the analyzing the plurality of status reports comprises ranking, based on the current activity level of each of the plurality of user devices, the plurality of user devices.

6. The method of claim 1, wherein the causing display of a notification comprises:
receiving, from an agent of a user device of the plurality of user devices, the notification; and
sending, to the agent and based on determining that the user device is active, an instruction to display the notification.

7. The method of claim 1, further comprising:
receiving, from the plurality of user devices and at a time different from a time when the plurality of status reports is received, a plurality of second status reports, wherein each of the plurality of second status reports indicates a currently active level of a respective user device, of the plurality of user devices;
determining, based on the plurality of second status reports, that each of the plurality of user devices is inactive; and
storing, to a queue, the notification, wherein the queue is configured to store notifications to be displayed in a future time.

8. The method of claim 1, wherein the causing display of the notification comprises:
causing, on a first user device of the one or more user devices, display of the notification;
determining the notification is not read by a user associated with the first user device within a predetermined time period; and
causing, on a second user device of the one or more user devices, display of the notification.

9. An apparatus comprising:
one or more processors; and
memory storing instructions that, when executed by the one or more processors, cause the apparatus to:
determine a plurality of user devices that are connected with a user account;
receive, from the plurality of user devices, a plurality of status reports, wherein each of the plurality of status reports indicates a currently active level of a respective user device of the plurality of user devices;
analyze the plurality of status reports;
select, based on the analyzing and from the plurality of user devices, one or more user devices that are currently active, wherein a quantity of the one or more user devices is fewer than a quantity of the plurality of user devices; and
cause, on the one or more user devices, display of a notification associated with the user account, wherein causing display of the notification further comprises:
determining that the notification is associated with an application that is not executed on the one or more user devices;
modifying the notification to a format suitable to be executed on the one or more user devices; and
causing, on the one or more user devices, display of the modified notification.

10. The apparatus of claim 9, wherein each of the plurality of status reports comprises at least one of:
a power status parameter, a screen-lock status parameter, an input event parameter, an audio event status, or a video event status.

11. The apparatus of claim 9, wherein the instructions, when executed by the one or more processors, cause the apparatus further to:
select, based on the analyzing and among the plurality of user devices, one or more second user devices that are inactive; and
block, the notification from being displayed on the one or more second user devices.

12. The apparatus of claim 9, wherein the instructions, when executed by the one or more processors, cause the apparatus to cause display of the notification by performance of actions comprising:
receiving, from an agent of a user device of the plurality of user devices, the notification; and
sending, to the agent and based on determining that the user device is active, an instruction to display the notification.

13. The apparatus of claim 9, wherein the instructions, when executed by the one or more processors, cause the apparatus further to:
receive, from the plurality of user devices and at a time different from a time when the plurality of status reports is received, a plurality of second status reports, wherein each of the plurality of second status reports indicates a currently active level of a respective user device, of the plurality of user devices;
determine, based on the plurality of second status reports, that each of the plurality of user devices is inactive; and
store, to a queue, the notification, wherein the queue is configured to store notifications to be displayed in a future time.

14. The apparatus of claim 9, wherein the instructions, when executed by the one or more processors, cause the apparatus to cause display of the notification by performance of actions comprising:
causing, on a first user device of the one or more user devices, display of the notification;
determining the notification is not read by a user associated with the first user device within a predetermined time period; and
causing, on a second user device of the one or more user devices, display of the notification.

15. A non-transitory computer-readable medium storing computer instruction that, when executed by one or more processors of a computing device, cause:
determining a plurality of user devices that are connected with a user account;
receiving, from the plurality of user devices, a plurality of status reports, wherein each of the plurality of status reports indicates a currently active level of a respective user device of the plurality of user devices;
analyzing the plurality of status reports;
selecting, based on the analyzing and from the plurality of user devices, one or more user devices that are currently active, wherein a quantity of the one or more user devices is fewer than a quantity of the plurality of user devices; and
causing, on the one or more user devices, display of a notification associated with the user account, wherein causing display of the notification further comprises:
determining that the notification is associated with an application that is not executed on the one or more user devices;
modifying the notification to a format suitable to be executed on the one or more user devices; and
causing, on the one or more user devices, display of the modified notification.

16. The non-transitory computer-readable medium of claim 15, wherein each of the plurality of status reports comprises at least one of:
a power status parameter, a screen-lock status parameter, an input event parameter, an audio event status, or a video event status.

17. The non-transitory computer-readable medium of claim 15, wherein the instructions, when executed by the one or more processors, cause the computing device further to perform actions comprising:
selecting, based on the analyzing and among the plurality of user devices, one or more second user devices that are inactive; and
blocking, the notification from being displayed on the one or more second user devices.

18. The non-transitory computer-readable medium of claim 15, wherein the instructions, when executed by the one or more processors, cause the computing device to analyze the plurality of status reports by ranking, based on the current activity level of each of the plurality of user devices, the plurality of user devices.

19. The non-transitory computer-readable medium of claim 15, wherein the instructions, when executed by the one or more processors, cause the computing device to cause display of the notification by performance of actions comprising:
receiving, from an agent of a user device of the plurality of user devices, the notification; and
sending, to the agent and based on determining that the user device is active, an instruction to display the notification.

20. The non-transitory computer-readable medium of claim 15, wherein the instructions, when executed by the one or more processors, cause the computing device further to perform actions comprising:
receiving, from the plurality of user devices and at a time different from a time when the plurality of status reports is received, a plurality of second status reports, wherein each of the plurality of second status reports indicates a currently active level of a respective user device, of the plurality of user devices;
determining, based on the plurality of second status reports, that each of the plurality of user devices is inactive; and
storing, to a queue, the notification, wherein the queue is configured to store notifications to be displayed in a future time.
